(19) United States
(12) Patent Application Publication
(10) Pub. No.: US 2022/0374055 A1
(43) Pub. Date: Nov. 24, 2022

(54) ELECTRONIC DEVICE WITH IMAGE-CAPTURING FUNCTION AND SHIELDING MEMBER THEREOF

(71) Applicant: Acer Incorporated, New Taipei City (TW)

(72) Inventors: Chun-Hung WEN, New Taipei City (TW); Chun-Hsien CHEN, New Taipei City (TW); Hui-Ping SUN, New Taipei City (TW)

(21) Appl. No.: 17/741,657

(22) Filed: May 11, 2022

(30) Foreign Application Priority Data
May 21, 2021 (TW) 110118410

(51) Int. Cl. G06F 1/16; H04N 5/225; G03B 5/00; G03B 11/06; G03B 30/00

(52) U.S. Cl. CPC G06F 1/1686; H04N 5/2252; H04N 5/2254; G03B 5/00; G03B 11/06; G03B 30/00

(57) ABSTRACT

An electronic device with an image-capturing function is provided. The electronic device includes a device housing, an image-capturing unit and a shielding member. The device housing includes a first slot and a second slot. The image-capturing unit is disposed in the device housing, wherein the image-capturing unit comprises a lens, and the lens is adapted to capture an image. The shielding member is slidably disposed in the device housing, wherein the shielding member comprises a first restriction block and a second restriction block. The first restriction block is inserted into the first slot, and the second restriction block is inserted into the second slot. The shielding member is adapted to slide between a first member position and a second member position in a first direction.

### CROSS REFERENCE TO RELATED APPLICATIONS

This Application claims priority of Taiwan Patent Application No. 110118410, filed on May 21, 2021, the entirety of which is incorporated by reference herein.

### BACKGROUND OF THE INVENTION

### Field of the Invention

The present invention relates to an electronic device, and in particular to an electronic device with an image-capturing function.

### Description of the Related Art

A conventional electronic device (such as a notebook computer) may have an image-capturing unit to capture an image. To protect the privacy of the user, a shielding member is utilized in the notebook computer. The shielding member is slidable, and is adapted to shield the image-capturing unit. However, conventional shielding members are huge, and may interfere with adjacent elements. A conventional shielding member therefore cannot be utilized in an electronic device with a narrow-border screen.

### BRIEF SUMMARY OF THE INVENTION

Embodiments of the invention are provided to address the aforementioned difficulty.

In one embodiment, an electronic device with an image-capturing function is provided. The electronic device includes a device housing, an image-capturing unit and a shielding member. The device housing includes a first slot and a second slot. The image-capturing unit is disposed in the device housing, wherein the image-capturing unit comprises a lens, and the lens is adapted to capture an image. The shielding member is slidably disposed in the device housing. The shielding member comprises a first restriction block and a second restriction block. The first restriction block is inserted into the first slot, and the second restriction block is inserted into the second slot. The shielding member is adapted to slide between a first member position and a second member position in a first direction. When the shielding member is in the first member position, the lens is adapted to capture an image. When the shielding member is in the second member position, the lens is shielded by the shielding member. Relative to the lens, the first restriction block and the second restriction block are located on the same side of the image-capturing unit. The first restriction block and the second restriction block restrict the movement of the shielding member in a second direction. The second direction is perpendicular to the first direction.

In one embodiment, the shielding member further comprises a central rib, and the second restriction block is formed on the central rib.

In one embodiment, the shielding member comprises a member positioning portion. The device housing comprises a first housing positioning portion and a second housing positioning portion. When the shielding member is in the first member position, the member positioning portion is wedged against the first housing positioning portion. When the shielding member is in the second member position, the member positioning portion is wedged against the second housing positioning portion.

In one embodiment, the member positioning portion comprises a protrusion. The first housing positioning portion comprises a first recess. The second housing positioning portion comprises a second recess. When the shielding member is in the first member position, the protrusion is wedged against the first recess. When the shielding member is in the second member position, the protrusion is wedged against the second recess.

In one embodiment, when the shielding member is in the first member position, the member positioning portion is wedged against the first housing positioning portion in the second direction. When the shielding member is in the second member position, the member positioning portion is wedged against the second housing positioning portion in the second direction.

In one embodiment, the shielding member further comprises a hook. The device housing comprises a third slot. The hook is inserted into the third slot and abuts the inner wall of the third slot to restrict the movement of the shielding member in a third direction. The third direction is perpendicular to the first direction and the second direction.

In one embodiment, the central rib corresponds to the upper edge of the image-capturing unit.

In one embodiment, the shielding member further comprises a spacing rib, which is adapted to abut the image-capturing unit to keep a distance between the shielding member and the lens.

In one embodiment, the shielding member comprises a member body, a first extending portion, and a second extending portion. The first extending portion is disposed on one side of the member body. The second extending portion is disposed on the other side of the member body. The central rib extends on the member body, the first extending portion and the second extending portion. The hook is formed on the free end of the first extending portion. The member positioning portion is formed on the free end of the second extending portion.

In one embodiment, the shielding member further comprises a member window. The lens captures an image via the member window. The member window is formed on the first extending portion.

In one embodiment, the hook is formed on the central rib, and the member positioning portion is formed on the central rib.

In one embodiment, the shielding member further comprises a holding portion, which is formed on one side of the member body. The device housing comprises a housing notch. The holding portion is exposed in the housing notch and is adapted to be pushed.

In one embodiment, a shielding member adapted to shield a lens of an image-capturing unit is provided. The shielding member includes a member body, a first extending portion, a second extending portion, a central rib, a first restriction block, and a second restriction block. The first extending portion is disposed on one side of the member body. The second extending portion is disposed on the other side of the member body. The central rib extends on the member body, the first extending portion and the second extending portion. The first restriction block is formed on the member body. The second restriction block is formed on the central rib.

In one embodiment, the shielding member further comprises a hook and the member positioning portion. The hook is formed on the free end of the first extending portion, and the member positioning portion is formed on the free end of the second extending portion.

In one embodiment, the shielding member further comprises a holding portion and a spacing rib. The holding portion is formed on one side of the member body, and the spacing rib is formed on the member body.

In the embodiment of the invention, the first restriction block and the second restriction block restrict the movement of the shielding member in the second direction. Relative to the lens, the first restriction block and the second restriction block are located on the same side of the image-capturing unit. Therefore, the size of the shielding member can be decreased, and the inner space of the electronic device can be used effectively. The shielding member of the embodiment of the invention can be utilized in the electronic device with a narrow-border screen.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a perspective view of an electronic device with an image-capturing function of an embodiment of the invention;

FIG. 2A is an exploded view of the electronic device of the embodiment of the invention;

FIG. 2B shows the details of the device housing of the embodiment of the invention;

FIG. 3 shows the details of the shielding member of the embodiment of the invention;

FIGS. 4A and 4B show the shielding member combined to the device housing of the embodiment of the invention, wherein shielding member is shown in dotted line;

FIGS. 5A and 5B show the shielding member combined to the device housing of the embodiment of the invention, wherein shielding member is shown in solid line;

FIG. 6 shows the hook connected to the third slot of the embodiment of the invention; and

FIG. 7 shows the relative positions of the spacing rib and the image-capturing unit.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

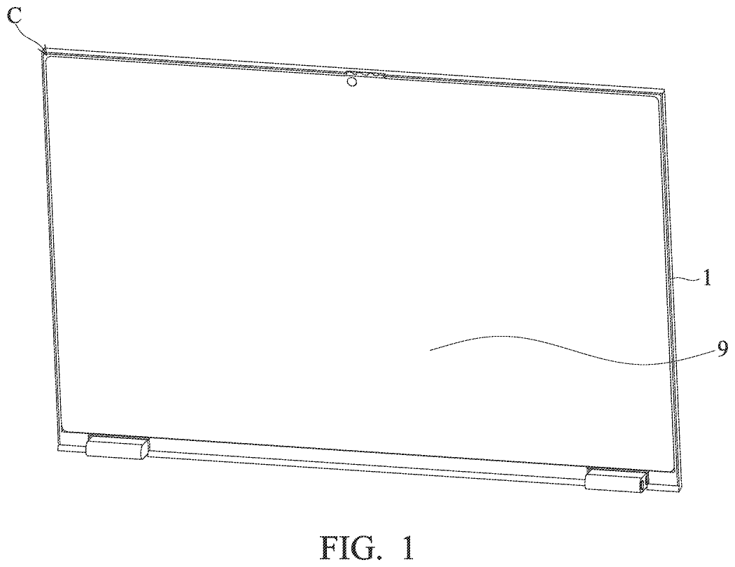

FIG. 1 is a perspective view of an electronic device with an image-capturing function of an embodiment of the invention. With reference to FIG. 1, the electronic device may include a cover C of a notebook computer. The cover C has a screen element 9 (such as a screen glass) and a device housing 1.

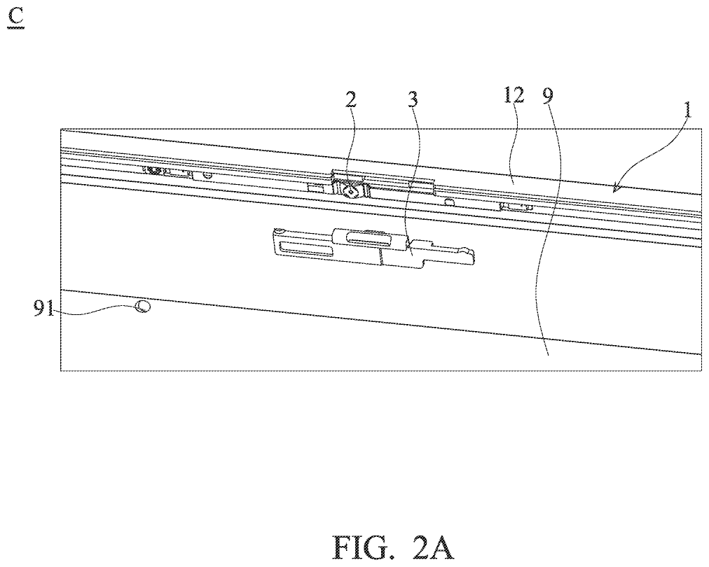

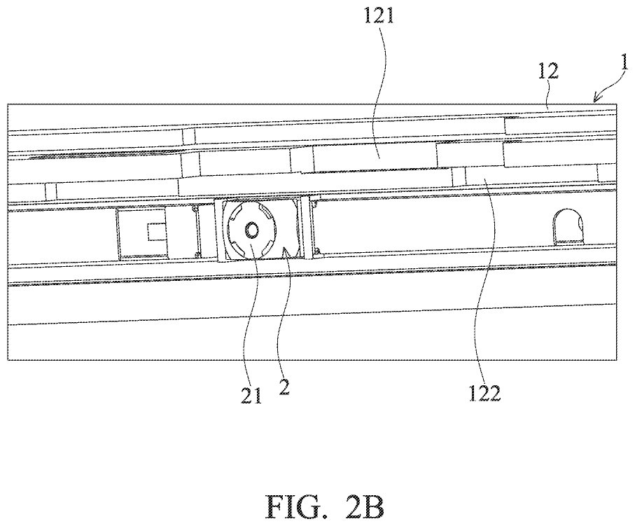

FIG. 2A is an exploded view of the electronic device of the embodiment of the invention. FIG. 2B shows the details of the device housing of the embodiment of the invention. With reference to FIGS. 2A and 2B, the electronic device (the cover C shown in FIGS. 2A and 2B) includes a device housing 1, an image-capturing unit 2 and a shielding member 3. The device housing 1 includes a back housing member 12. An element window 91 is formed on the screen element 9. The back housing member 12 includes a first slot 121 and a second slot 122. The image-capturing unit 2 is disposed in the device housing 1. The image-capturing unit 2 comprises a lens 21. The lens 12 is adapted to capture an image via the element window 91. The shielding member 3 is slidably disposed in the device housing 1. The shielding member 3 is sandwiched between the screen element 9 and the device housing 1.

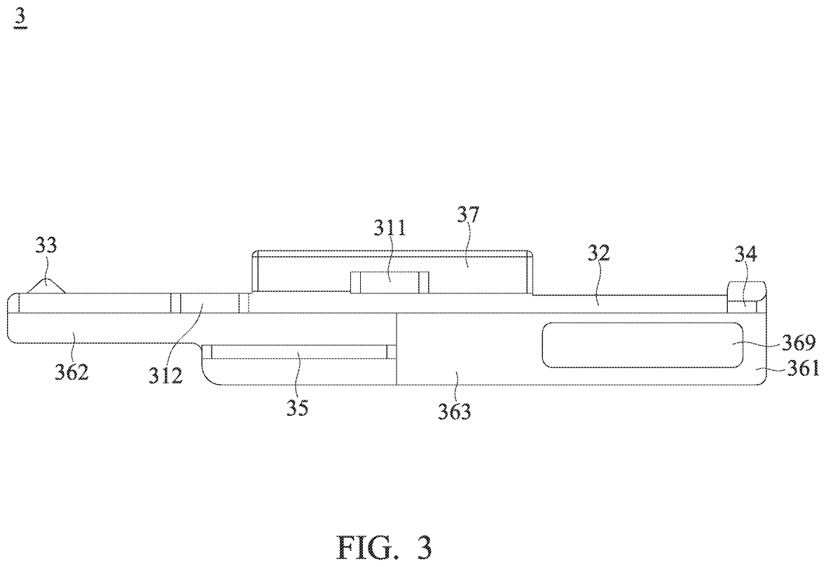

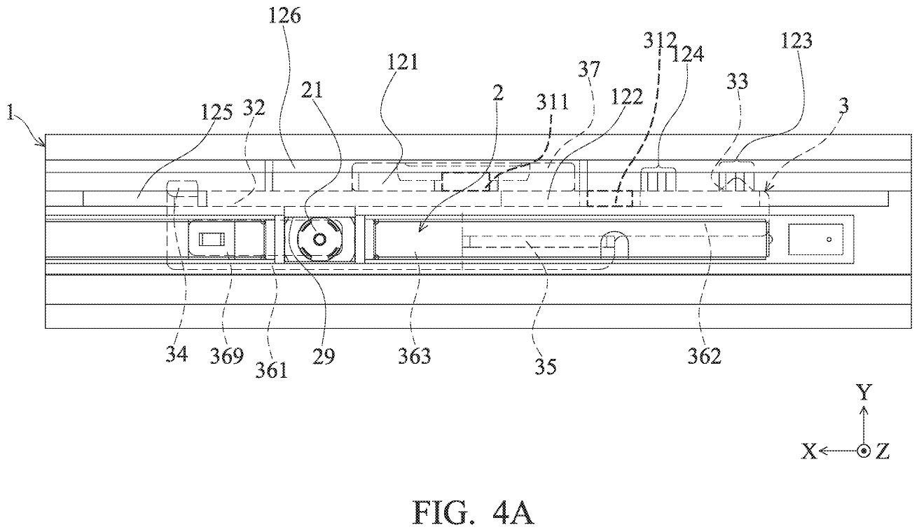

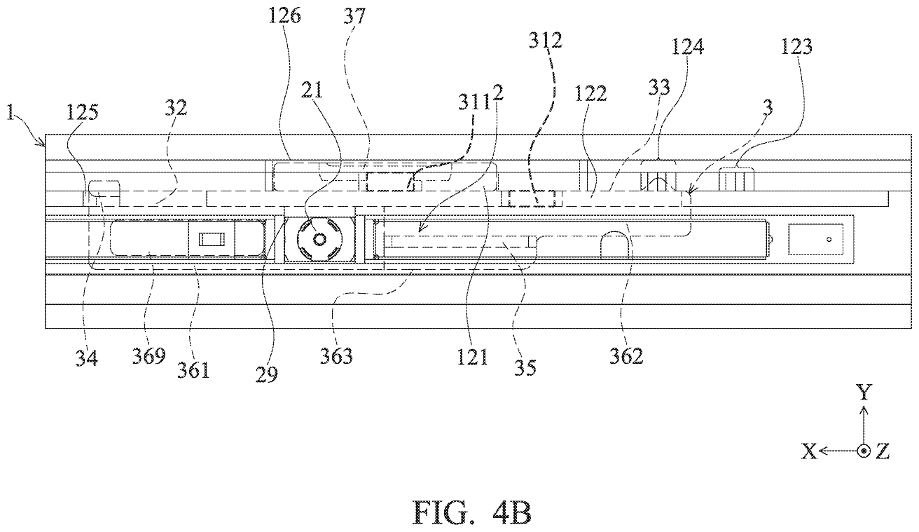

FIG. 3 shows the details of the shielding member of the embodiment of the invention. FIGS. 4A and 4B show the shielding member combined to the device housing of the embodiment of the invention, wherein shielding member is shown in dotted line. With reference to FIGS. 3, 4A and 4B, in one embodiment, the shielding member 3 comprises a first restriction block 311 and a second restriction block 312. The first restriction block 311 is inserted into the first slot 121. The second restriction block 312 is inserted into the second slot 122. The shielding member 3 is adapted to slide between a first member position (FIG. 4A) and a second member position (FIG. 4B) in a first direction X.

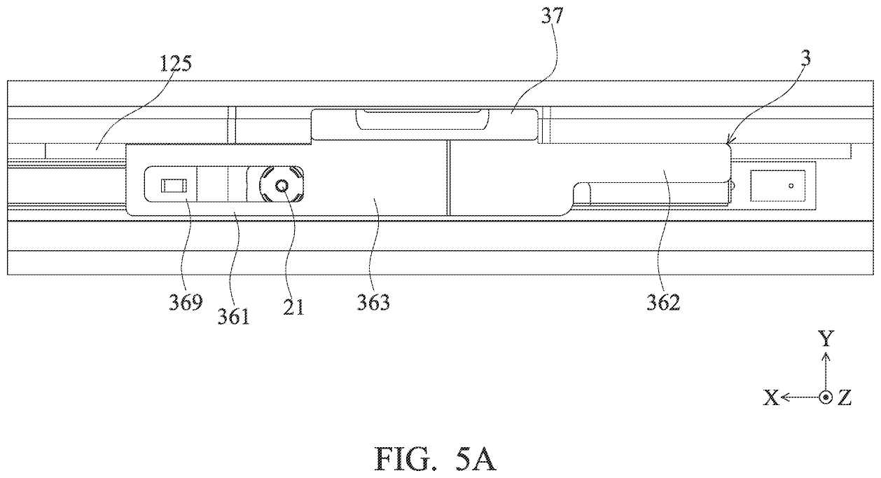

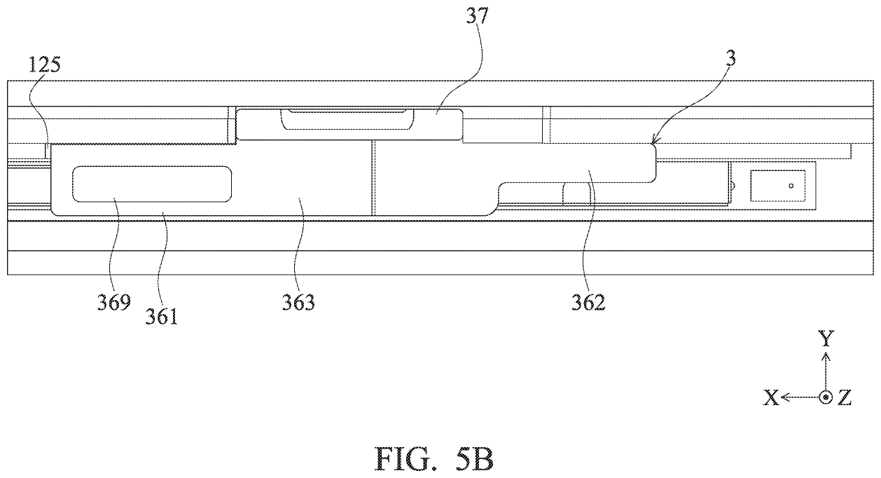

FIGS. 5A and 5B show the shielding member combined to the device housing of the embodiment of the invention, wherein shielding member is shown in solid line. With reference to FIGS. 4A, 4B, 5A and 5B, when the shielding member 3 is in the first member position (FIGS. 4A and 5A), the lens 21 is adapted to capture the image. When the shielding member 3 is in the second member position (FIGS. 4B and 5B), the lens 21 is shielded by the shielding member 3. Relative to the lens 21, the first restriction block 311 and the second restriction block 312 are located on the same side of the image-capturing unit 2. The first restriction block 311 and the second restriction block 312 restrict the movement of the shielding member 3 in a second direction Y, and the second direction Y is perpendicular to the first direction X.

With reference to FIGS. 3, 4A and 4B, in one embodiment, the shielding member 3 further comprises a central rib 32, and the second restriction block 312 is formed on the central rib 32.

With reference to FIGS. 3, 4A and 4B, in one embodiment, the shielding member 3 comprises a member positioning portion 33. The device housing 1 comprises a first housing positioning portion 123 and a second housing positioning portion 124. When the shielding member 3 is in the first member position, the member positioning portion 33 is wedged against the first housing positioning portion 123. When the shielding member 3 is in the second member position, the member positioning portion 33 is wedged against the second housing positioning portion 124. Therefore, the shielding member 3 can stably stay in the first member position or the second member position.

With reference to FIGS. 3, 4A and 4B, in one embodiment, the member positioning portion 33 comprises a protrusion (33). The first housing positioning portion 123 comprises a first recess (123). The second housing positioning portion 124 comprises a second recess (124). When the shielding member 3 is in the first member position, the protrusion (33) is wedged against the first recess (123). When the shielding member 3 is in the second member position, the protrusion (33) is wedged against the second recess (124).

With reference to FIGS. 4A, 4B, 5A and 5B, in one embodiment, when the shielding member 3 is in the first member position, the member positioning portion 33 is wedged against the first housing positioning portion 123 in the second direction Y. When the shielding member 3 is in the second member position, the member positioning portion 33 is wedged against the second housing positioning portion 124 in the second direction Y.

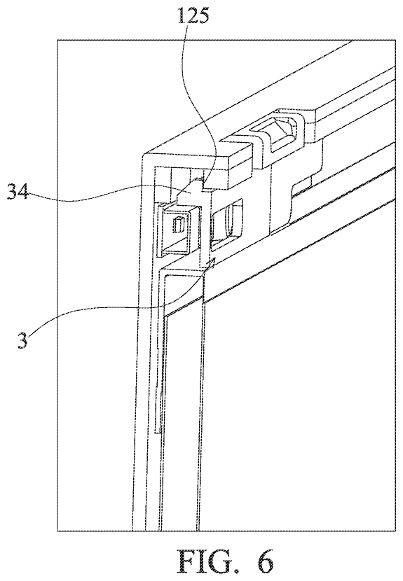

With reference to FIGS. 3, 4A and 4B, in one embodiment, the shielding member 3 further comprises a hook 34. The device housing 1 comprises a third slot 125. The hook 34 is inserted into the third slot 125 and abuts an inner wall of the third slot 125 to restrict the movement of the shielding member 3 in a third direction Z. The third direction Z is perpendicular to the first direction X and the second direction Y. FIG. 6 shows the hook connected to the third slot of the embodiment of the invention. With reference to FIG. 6, the hook 34 is inserted into the third slot 125 and abuts the inner wall of the third slot 125. The hook 34 prevents the shielding member 3 from being separated from the device housing during assembly process, and the assembly efficiency is thus improved.

With reference to FIGS. 4A and 4B, in one embodiment, the central rib 32 corresponds to an upper edge 29 of the image-capturing unit 2. The central rib 32 provides shielding function.

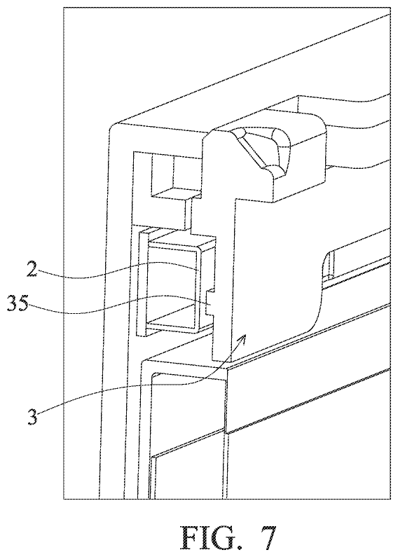

With reference to FIGS. 3, 4A and 4B, in one embodiment, the shielding member 3 further comprises a spacing rib 35. The spacing rib 35 is adapted to abut the image-capturing unit 2 to keep a distance between the shielding member 3 and the lens 21. FIG. 7 shows the relative positions of the spacing rib and the image-capturing unit. With reference to FIG. 7, the spacing rib 35 is adapted to abut the image-capturing unit 2 to keep the distance between the shielding member 3 and the lens 21. The lens 21 is thus prevented from being stricken by the shielding member 3.

With reference to FIGS. 3, 4A and 4B, in one embodiment, the shielding member 3 comprises a member body 363, a first extending portion 361 and the second extending portion 362. The first extending portion 361 is disposed on one side of the member body 363. The second extending portion 362 is disposed on the other side of the member body 363. The central rib 32 extends on the member body 363, the first extending portion 361 and the second extending portion 362. The hook 34 is formed on the free end of the first extending portion 361, and the member positioning portion 33 is formed on the free end of the second extending portion 362.

With reference to FIGS. 3, 4A and 4B, in one embodiment, the shielding member 3 further comprises a member window 369. The lens 21 captures the image via the member window 369 and the element window, and the member window 369 is formed on the first extending portion 361.

In this embodiment, the first extending portion 361 includes the member window 369, and the first extending portion 361 thus has decreased strength and improved elastic deformation ability. The hook 34 can be inserted into the third slot 125 via the elastic deformation of the first extending portion 361. The second extending portion 362 is a cantilever beam. The second extending portion 362 has decreased strength and improved elastic deformation ability. The member positioning portion 33 is wedged against the first housing positioning portion 123 or the second housing positioning portion 124 via the elastic deformation of the second extending portion 362. However, the disclosure is not meant to restrict the invention. For example, in another embodiment, the second extending portion 362 can include the member window, and the first extending portion 361 can be a cantilever beam.

With reference to FIGS. 3, 4A and 4B, in one embodiment, the hook 34 is formed on the central rib 32. The member positioning portion 33 is formed on the central rib 32.

With reference to FIGS. 3, 4A and 4B, in one embodiment, the shielding member 3 further comprises a holding portion 37. The holding portion 37 is formed on one side of the member body 361. The device housing 1 comprises a housing notch 126. The holding portion 37 is exposed in the housing notch 126 and is adapted to be pushed.

In the embodiment of the invention, the first restriction block and the second restriction block restrict the movement of the shielding member in the second direction. Relative to the lens, the first restriction block and the second restriction block are located on the same side of the image-capturing unit. Therefore, the size of the shielding member can be decreased, and the inner space of the electronic device can be used effectively. Particularly, the shielding member of the embodiment of the invention can be utilized in the electronic device with a narrow-border screen.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term).

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronic device with an image-capturing function, comprising:
a device housing, comprising a first slot and a second slot;
an image-capturing unit, disposed in the device housing, wherein the image-capturing unit comprises a lens, and the lens is adapted to capture an image;
a shielding member, slidably disposed in the device housing, wherein the shielding member comprises a first restriction block and a second restriction block, the first restriction block is inserted into the first slot, the second restriction block is inserted into the second slot, the shielding member is adapted to slide between a first member position and a second member position in a first direction, and when the shielding member is in the first member position, the lens is adapted to capture the image, and when the shielding member is in the second member position, the lens is shielded by the shielding member,
wherein relative to the lens, the first restriction block and the second restriction block are located on the same side of the image-capturing unit, the first restriction block and the second restriction block restrict the movement of the shielding member in a second direction, and the second direction is perpendicular to the first direction.

2. The electronic device as claimed in claim 1, wherein the shielding member further comprises a central rib, and the second restriction block is formed on the central rib.

3. The electronic device as claimed in claim 2, wherein the shielding member comprises a member positioning portion, the device housing comprises a first housing positioning portion and a second housing positioning portion, and when the shielding member is in the first member position, the member positioning portion is wedged against the first housing positioning portion, and when the shielding member is in the second member position, the member positioning portion is wedged against the second housing positioning portion.

4. The electronic device as claimed in claim 3, wherein the member positioning portion comprises a protrusion, the first housing positioning portion comprises a first recess, the second housing positioning portion comprises a second recess, and when the shielding member is in the first member position, the protrusion is wedged against the first recess, and when the shielding member is in the second member position, the protrusion is wedged against the second recess.

5. The electronic device as claimed in claim 3, wherein when the shielding member is in the first member position, the member positioning portion is wedged against the first housing positioning portion in the second direction, and when the shielding member is in the second member position, the member positioning portion is wedged against the second housing positioning portion in the second direction.

6. The electronic device as claimed in claim 3, wherein the shielding member further comprises a hook, the device housing comprises a third slot, the hook is inserted into the third slot and abuts an inner wall of the third slot to restrict the movement of the shielding member in a third direction, wherein the third direction is perpendicular to the first direction and the second direction.

7. The electronic device as claimed in claim 6, wherein the central rib corresponds to an upper edge of the image-capturing unit.

8. The electronic device as claimed in claim 6, wherein the shielding member further comprises a spacing rib, and the spacing rib is adapted to abut the image-capturing unit to keep a distance between the shielding member and the lens.

9. The electronic device as claimed in claim 6, wherein the shielding member comprises a member body, a first extending portion, and a second extending portion, the first extending portion is disposed on one side of the member body, the second extending portion is disposed on the other side of the member body, the central rib extends on the member body, the first extending portion and the second extending portion, the hook is formed on a free end of the first extending portion, and the member positioning portion is formed on a free end of the second extending portion.

10. The electronic device as claimed in claim 9, wherein the shielding member further comprises a member window, the lens captures an image via the member window, and the member window is formed on the first extending portion.

11. The electronic device as claimed in claim 9, wherein the hook is formed on the central rib, and the member positioning portion is formed on the central rib.

12. The electronic device as claimed in claim 9, wherein the shielding member further comprises a holding portion, the holding portion is formed on one side of the member body, the device housing comprises a housing notch, and the holding portion is exposed in the housing notch and is adapted to be pushed.

13. A shielding member, adapted to shield a lens of an image-capturing unit, comprising:
a member body;
a first extending portion, disposed on one side of the member body;
a second extending portion, disposed on the other side of the member body;
a central rib, extending on the member body, the first extending portion and the second extending portion;
a first restriction block, formed on the member body; and
a second restriction block, formed on the central rib.

14. The shielding member as claimed in claim 13, wherein the shielding member further comprises a hook and the member positioning portion, the hook is formed on the free end of the first extending portion, and the member positioning portion is formed on the free end of the second extending portion.

15. The shielding member as claimed in claim 14, wherein the hook is formed on the central rib, and the member positioning portion is formed on the central rib.

16. The shielding member as claimed in claim 15, wherein the shielding member further comprises a holding portion and a spacing rib, the holding portion is formed on one side of the member body, and the spacing rib is formed on the member body.
